(19) United States
(12) Patent Application Publication
(10) Pub. No.: US 2022/0020099 A1
(43) Pub. Date: Jan. 20, 2022

(54) PROFILE EVALUATION APPARATUS AND NON-TRANSITORY COMPUTER READABLE MEDIUM

(71) Applicant: FUJIFILM BUSINESS INNOVATION CORP., Tokyo (JP)

(72) Inventors: Junichi TAMURA, Kanagawa (JP); Chizuko SENTO, Kanagawa (JP)

(73) Assignee: FUJIFILM BUSINESS INNOVATION CORP., Tokyo (JP)

(21) Appl. No.: 17/144,664

(22) Filed: Jan. 8, 2021

(30) Foreign Application Priority Data
Jul. 17, 2020 (JP) 2020-123025

(51) Int. Cl. G06Q 50/00; H04L 29/08; G06Q 10/06

(52) U.S. Cl. CPC G06Q 50/01; G06Q 10/063112; H04L 67/306

(57) ABSTRACT

A profile evaluation apparatus includes a processor configured to evaluate, in a case where users register profiles of the users, credibility of a profile item of a target user input to a profile publication service, which publishes the registered profiles, on a basis of information regarding the target user managed for a social networking service.

### CROSS-REFERENCE TO RELATED APPLICATIONS

This application is based on and claims priority under 35 USC 119 from Japanese Patent Application No. 2020-123025 filed Jul. 17, 2020.

### BACKGROUND

### (i) Technical Field

The present disclosure relates to a profile evaluation apparatus and a non-transitory computer readable medium.

### (ii) Related Art

Japanese Unexamined Patent Application Publication No. 2002-203244 discloses an authentication information issuance apparatus that authenticates a user by comparing face photograph information included in an identification card of the user and a face image obtained by capturing the user's face.

Japanese Unexamined Patent Application Publication No. 2011-28592 discloses an identity verification system that checks address information transmitted from a user on the basis of a photograph of the user's face and information indicating a place where the photograph has been captured, which have been transmitted from a mobile terminal having a camera function and a global positioning system (GPS) function.

### SUMMARY

Profile publication services in which users register profiles thereof and the registered profiles are published are known. Examples of such a profile publication service include matching services such as a job matching service and a dating service.

Conventionally, the credibility of a profile item input by a user in a profile publication service might not be evaluated. In this case, the user can undesirably input an unreal (i.e., fake) profile item to the profile publication service. If a fake profile item is registered, a disadvantage might be caused to a viewer who views the profile item.

Aspects of non-limiting embodiments of the present disclosure relate to evaluation of the credibility of profile items input to a profile publication service, which publishes profiles.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a profile evaluation apparatus including a processor configured to evaluate, in a case where users register profiles of the users, credibility of a profile item of a target user input to a profile publication service, which publishes the registered profiles, on a basis of information regarding the target user managed for a social networking service.

### BRIEF DESCRIPTION OF THE DRAWINGS

An exemplary embodiment of the present disclosure will be described in detail based on the following figures, wherein:

FIG. 1 is a schematic diagram illustrating the configuration of a profile evaluation system according to an exemplary embodiment;

FIG. 2 is a diagram illustrating an example of a profile display screen provided by a profile publication service;

FIG. 3 is a diagram illustrating an example of a screen provided by a social networking service;

FIG. 4 is a schematic diagram illustrating the configuration of the profile evaluation apparatus according to the exemplary embodiment;

FIG. 5 is a diagram illustrating an example of names of schools of related users, who relate to a target user, obtained from the social networking service;

FIG. 6 is a diagram illustrating an example of weights for the related users in the social networking service;

FIG. 7 is a diagram illustrating an example of a notification screen for notifying the target user that it is difficult to analyze the credibility of a profile item because the number of friends in the social networking service is too small;

FIG. 8 is a diagram illustrating an example of a notification screen for notifying the target user that the amount of processing for analyzing the credibility of a profile item because the number of friends in the social networking service is too large;

FIG. 9 is a diagram illustrating restriction of inputting of a profile item on a profile input screen;

FIG. 10 is a diagram illustrating an example of a profile display screen on which a profile item is displayed in a mode according to credibility; and

FIG. 11 is a flowchart illustrating a process performed by the profile evaluation apparatus according to the exemplary embodiment.

### DETAILED DESCRIPTION

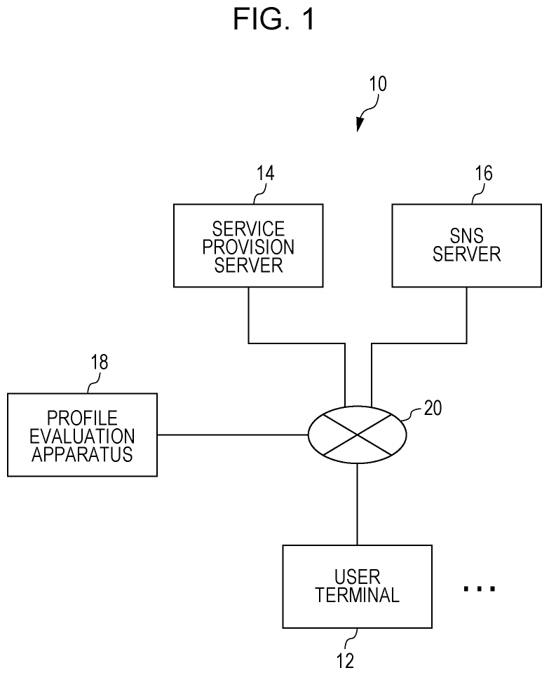

FIG. 1 is a schematic diagram illustrating the configuration of a profile evaluation system 10 according to an exemplary embodiment. The profile evaluation system 10 includes at least one user terminal 12, a service provision server 14, at least one social networking service (SNS) server 16, and a profile evaluation apparatus 18. The user terminal 12, the service provision server 14, the SNS server 16, and the profile evaluation apparatus 18 are communicably connected to one another by a communication network 20 such as a local area network (LAN) or the Internet.

The user terminal 12 is used by a user of the profile evaluation system 10. The user terminal 12 is, for example, a desktop personal computer or a mobile terminal such as a smartphone or a tablet terminal. The user terminal 12 includes a communication interface for communicating with other apparatuses, a memory including a hard disk drive (HDD), a solid-state drive (SSD), a read-only memory (ROM), or a random-access memory (RAM), a display including a liquid crystal display, an input interface including a mouse and a keyboard or a touch panel, and a processor including a central processing unit (CPU) or a microcomputer.

The service provision server 14 is achieved, for example, by a server computer. The service provision server 14 may be achieved by a single apparatus or plural apparatuses. The service provision server 14 provides a profile publication service, to which the user registers a profile thereof and which publishes the profile. The profile publication service is, for example, a matching service such as a job matching service or a dating service, but may be any service insofar as the user can register the profile thereof and the registered profile is published.

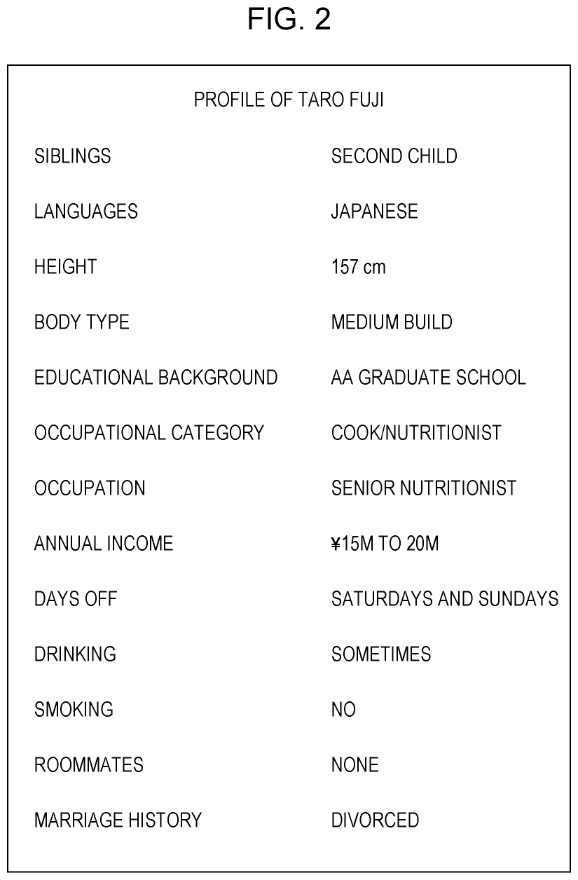

Once the user accesses the service provision server 14, that is, the profile publication service, using the user terminal 12 and registers himself/herself to the profile publication service, the user can register the profile thereof. Other users can view the registered profile by accessing the profile publication service. FIG. 2 illustrates an example of a profile display screen on which a profile registered to the profile publication service is displayed.

A profile is information indicating a user's character. In other words, a profile is attribute information indicating characteristics of a user. A profile is used by a person who does not know a user to get to know the user or evaluate the user. The term “profile” herein refers to information registered by a user for one or more profile items, that is, a set of setting values for the profile items (here, the “values” are not limited to numerical values).

In the present exemplary embodiment, a profile includes, but is not limited to, physical information (e.g., height, weight, body type, etc.), official career information (educational background, business career, occupational category, occupation, annual income, days off, place of employment, title, qualifications, etc.), private career information (siblings, languages, roommates, marriage history, etc.) or preference information (drinking, smoking, hobbies, etc.) as illustrated in FIG. 2. Although FIG. 2 illustrates plural profile items, profile items to be used are not limited to those illustrated in FIG. 2.

The SNS server 16 is achieved, for example, by a server computer. The SNS server 16 may be achieved by a single apparatus or plural apparatuses. The SNS server 16 provides an SNS, which is a service for constructing a social network, for the user. Typical examples of the SNS include, but are not limited to, Facebook (registered trademark) and Twitter (registered trademark). Once the user accesses the SNS server 16, that is, the SNS, using the user terminal 12 and creates an account thereof, the user can use the SNS.

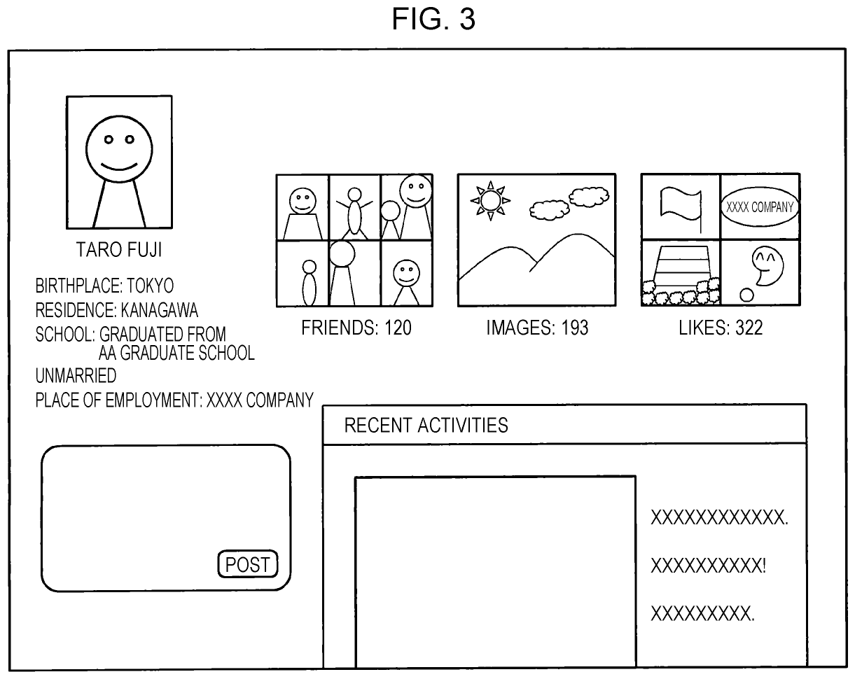

FIG. 3 illustrates an example of a screen displayed on the user terminal 12 while the user is using the SNS. The user can register basic data regarding himself/herself in the SNS provided by the SNS server 16. The basic data is information indicating the user's character, that is, attribute information indicating the characteristics of the user. That is, the basic data is equivalent to the profile registered to the profile publication service, but for the purpose of distinction from the profile in the profile publication service, information indicating the user registered to the SNS will be referred to as “basic data”. As with “profile”, the term “basic data” refers to information registered by the user as one or more data items, that is, a set of setting values for the data items (here, too, the “values” are not limited to numeral values).

In the example illustrated in FIG. 3, the basic data includes a photograph of the user, a name (account name), birthplace, residence, school, marriage history, and a place of employment. The basic data registered to the SNS, however, is not limited to these.

In the SNS, the user can post various pieces of information. “Posting” refers to registration of information to the SNS while associating the information with the user's account so that the user and other users of the SNS can view the information. The information may include text, images (e.g., photographs, moving images, etc.) and links to websites. In addition, the user can post information posted by other users while citing the information with the account thereof (share, retweet, etc.). When the user posts information on the SNS, posting time may be registered to the SNS along with the information. A place relating to the posted information (e.g., a place of a store mentioned in the information or a place where an image has been captured) may also be registered while being associated with the information. If the user posts information indicating that the user has spent time with another user who has an account for the SNS, the user can tag (link) the account of the other user in the information.

In the SNS, the user can leave comments for information posted by other users.

In the SNS, the user can evaluate information posted by an account other than the account thereof (e.g., an account of another individual user, a corporate account, etc.) or another account itself. For example, a “like” button is provided for information posted on the SNS, and the user can positively react to information posted by another account by pressing the “like” button provided for the information. The “like” button is also provided for other accounts themselves, and the user can positively react to another account by pressing the “like” button provided for the other account.

In the SNS, the user can define relationships with other users. More specifically, the user can define relationships between the account thereof and accounts of the other users on the SNS. If the user transmits a “friend request” to another user on the SNS and the other user approves the “friend request”, for example, an account of the other user is registered as a “friend” of the account of the user. The user may also define types of relationships between the account thereof and the accounts of the other users in the SNS. In addition to “friend”, the user can define a type of relationship between the account of the user and an account of a spouse, a parent, or a child thereof, for example, as “spouse”, “parent”, or “child”. Other users relating to the user on the SNS will be referred to as “related users” herein.

In the SNS, the user can define communities (groups of plural users). For example, plural users who have the same hobby participate in the same community. The user can create a community and wait for other users to participate, or participate in a community created by another user by transmitting a request. When a community is used, information can be posted on the SNS such that only users who have participated in the community can view the information.

The profile evaluation system 10 may include plural SNS servers 16, instead. In this case, the SNS servers 16 can provide different SNSs for the user.

The profile publication service provided by the service provision server 14 and the SNS provided by the SNS server 16 are different services, and providers of the services may be different from each other. In the profile evaluation system 10, however, registered users of the profile publication service and accounts for the SNS can be associated with each other. More specifically, the profile publication service manages user information in which user identifiers (IDs) for identifying the registered users and account IDs for identifying the accounts for the SNS are associated with each other. As a result, processing based on cooperation between the profile publication service and the SNS can be performed.

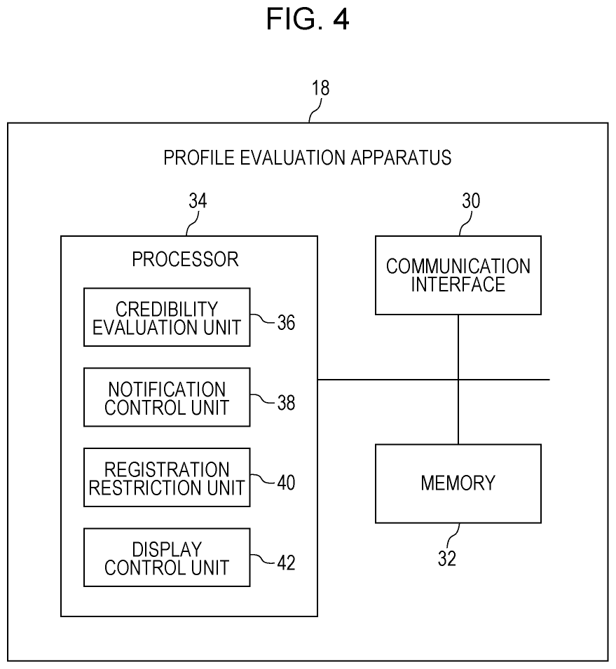

FIG. 4 is a schematic diagram illustrating the configuration of the profile evaluation apparatus 18. The profile evaluation apparatus 18 is achieved by a server, for example, but may be any apparatus insofar as functions that will be described hereinafter can be achieved. The following functions of the profile evaluation apparatus 18 may be achieved by cooperation between plural apparatuses, instead. In this case, the plural apparatuses serve as the profile evaluation apparatus 18.

In the present exemplary embodiment, the profile evaluation apparatus 18 is separate from the service provision server 14. Although the profile evaluation apparatus 18 performs processing in cooperation with the service provision server 14 (the profile publication service, especially), the components of the profile evaluation apparatus 18 may be incorporated into the service provision server 14, instead. Especially the functions achieved by the components of the profile evaluation apparatus 18 may be achieved by the profile publication service, instead.

A communication interface 30 includes, for example, a network adapter. The communication interface 30 achieves a function of communicating with other apparatuses over the communication network 20.

The memory 32 includes, for example, an HDD, an SSD, a ROM, or a RAM. The memory 32 may be provided separately from a processor 34, which will be described later, or at least a part of the memory 32 may be provided inside the processor 34. The memory 32 stores a profile evaluation program for operating the components of the profile evaluation apparatus 18.

The term “processor 34” refers to a processor in a broad sense. Examples of the processor 34 include general processors (e.g., a CPU) and dedicated processors (e.g., a graphics processing unit (GPU), an application-specific integrated circuit (ASIC), a field-programmable gate array (FPGA), and a programmable logic device). The term “processor 34” is broad enough to encompass one processor or plural processors in collaboration which are located physically apart from each other but may work cooperatively.

As illustrated in FIG. 4, the processor 34 achieves functions as a credibility evaluation unit 36, a notification control unit 38, a registration restriction unit 40, and a display control unit 42 using the profile evaluation program stored in the memory 32.

The credibility evaluation unit 36 evaluates the credibility of a profile item input by the user to the profile publication service provided by the service provision server 14. The credibility evaluation unit 36 evaluates the credibility of the profile item of the user especially on the basis of information regarding the user managed for the SNS provided by the SNS server 16. A user who has input a profile item to be evaluated by the credibility evaluation unit 36 will be referred to as a “target user” herein.

First, the credibility evaluation unit 36 refers to the above-mentioned user information managed by the profile publication service and identifies an account of a target user in the SNS. The credibility evaluation unit 36 then accesses the SNS and obtains information regarding the target user managed for the SNS. The credibility evaluation unit 36 evaluates the credibility of a profile item of the target user on the basis of the information regarding the target user obtained from the SNS.

Before the evaluation of the credibility of a profile item of the target user, the credibility evaluation unit 36 may obtain information regarding the target user from the SNS and hold the information in the memory 32. The credibility evaluation unit 36 may, however, obtain the information regarding the target user from the SNS when evaluating the credibility of the profile item of the target user, that is, more specifically, immediately before evaluating the credibility. Because the information regarding the target user in the SNS changes every moment, the credibility of a profile item of the target user can be evaluated on the basis of latest information regarding the target user in the SNS by obtaining the information immediately before the evaluation. If the credibility evaluation unit 36 evaluates the credibility of a profile item immediately after the target user inputs the profile item to the profile publication service, the credibility evaluation unit 36 may obtain the information regarding the target user from the SNS when the target user inputs the profile item to the profile publication service, that is, using the inputting of the profile item by the target user to the profile publication service as a trigger.

The credibility evaluation unit 36 can calculate the credibility of a profile item of the target user as an evaluation value (i.e., a numerical value). Any specific method for calculating the evaluation value may be used. An example of the specific method for calculating the evaluation value will be described in the following description. A learning device may also be used in the calculation of the evaluation value. In this case, the learning device can be trained using the information regarding the target user obtained from the SNS, the profile item input by the target user, and information (training data) indicating the authenticity of the profile item as data to be learned.

Alternatively, the credibility evaluation unit 36 may output, on the basis of a comparison between the calculated evaluation value and a preset evaluation threshold, the credibility of a profile item of the target user as a binary signal indicating whether the profile is real or fake (or possibly fake).

When the profile evaluation system 10 includes plural SNS servers 16 and account IDs of the target user for plural SNSs are associated with a user ID indicating the target user in the user information managed by the profile publication service, the credibility evaluation unit 36 may evaluate the credibility of a profile item of the target user on the basis of information regarding the target user obtained from the SNSs.

Specific examples of the evaluation of the credibility of various profile items of the target user based on various pieces of information regarding the target user obtained from the SNS will be described hereinafter. The credibility evaluation unit 36 can evaluate the credibility of a profile item of the target user using one of, or a combination of, the following methods.

### Method 1 for Evaluating Credibility of Profile Item

In a first method, the credibility evaluation unit 36 evaluates the credibility of a profile item of the target user on the basis of information posted by the target user on the SNS included in the information regarding the target user obtained from the SNS.

### Method 1-1 for Evaluating Credibility of Profile Item

The credibility evaluation unit 36 evaluates the credibility of a profile item of the target user on the basis of text posted by the target user in the SNS.

When a profile item “hobbies” of the target user is “listening to music”, for example, the credibility evaluation unit 36 increases the credibility of the profile item if the target user has written posts about music on the SNS. This is because it is estimated that the more the target user posts information regarding music in the SNS, the more likely the target user is to listen to music as a hobby.

When a profile item “body type” of the target user is “muscular”, for example, the credibility evaluation unit 36 increases the credibility of the profile item if the target user has written posts about gyms and exercise in the SNS. This is because it is estimated that the more the target user posts information regarding gyms and exercise on the SNS, the more likely the target user is to be interested in exercise, and the more likely the target user is to be muscular.

### Method 1-2 for Evaluating Credibility of Profile Item

The credibility evaluation unit 36 evaluates the reliability of a profile item of the target user on the basis of text posted by the target user on the SNS and times of the posting.

When a profile item “how to spend the days off” of the target user is “reading”, for example, the credibility evaluation unit 36 increases the credibility of the profile item if the target user has written posts about reading and books in the SNS on Saturdays, Sundays, and holidays. This is because it is estimated that the more the target user posts information regarding reading and books on the SNS on Saturdays, Sundays, and holidays, the more likely the target user is to read on days off.

When a profile item “age” of the target user is “30” (as of 2020), for example, the credibility evaluation unit 36 increases the credibility of the profile item if the target user has posted information regarding a college graduation trip on the SNS around 2012. If the target user has posted information regarding a college graduation trip on the SNS at a time not around 2012 (e.g., around 2000) when the profile item “age” of the target user is “30” (as of 2020), on the other hand, the credibility evaluation unit 36 reduces the credibility of the profile item. This is because a current age of the target user can be estimated from a year of the college graduation trip (i.e., a year of graduation from college) since people usually graduate from college around the age of 22.

### Method 1-3 for Evaluating Credibility of Profile Item

The credibility evaluation unit 36 evaluates the credibility of a profile item of the target user on the basis of a result of an analysis of images posted by the target user on the SNS.

When the profile item “hobbies” of the target user is “tennis”, for example, the credibility evaluation unit 36 increases the credibility of the profile item if photographs posted by the target user on the SNS show objects relating to tennis (e.g., a tennis racket, a tennis ball, etc.). This is because it is estimated that the more the target user posts a photograph showing an object relating to tennis on the SNS, the more likely the target user is to be interested in tennis.

When a profile item “drinking” or “smoking” of the target user is “yes”, for example, the credibility evaluation unit 36 increases the credibility of the profile item if photographs posted by the target user on the SNS show liquor or cigarettes. This is because it is estimated that the more the target user posts a photograph showing an object relating to drinking or smoking on the SNS, the more likely the target user is to drink or smoke.

The credibility evaluation unit 36 evaluates a profile item “annual income” of the target user, for example, in accordance with prices of objects shown in photographs posted by the target user on the SNS. More specifically, when the profile item “annual income” of the target user is a relatively large amount of money, the credibility evaluation unit 36 increases the credibility of the profile item if the photographs show luxury products, luxury cars, luxury houses, or the like. This is because it is estimated that the more the target user posts a photograph showing a luxury item on the SNS, the more likely the target user is to own luxury items and the more likely the annual income of the target user is to be high.

The credibility evaluation unit 36 calculates, for a profile item “height” of the target user, for example, the height of the target user by analyzing the target user's figure shown in photographs posted by the target user on the SNS and evaluates the credibility of the profile item. For example, the credibility evaluation unit 36 calculates the height of the target user by comparing an object that is shown together with the target user and whose height is known with the target user.

### Method 1-4 for Evaluating Credibility of Profile Item

The credibility evaluation unit 36 evaluates the credibility of a profile item of the target user on the basis of a place relating to information posted by the target user on the SNS.

### Method 1-4-1 for Evaluating Credibility of Profile Item

When a profile item “favorite place” of the target user is “art museum”, for example, the credibility evaluation unit 36 increases the credibility of the profile item if places where the target user has posted information on the SNS are art museums. This is because it is estimated that the more the target user posts information associated with an art museum on the SNS, the more likely the target user is to visit art museums frequently.

When the profile item “drinking” of the target user is “yes”, for example, the credibility evaluation unit 36 increases the credibility of the profile item if places where the target user has posted information on the SNS are bars. This is because it is estimated that the more the target user posts information associated with a bar on the SNS, the more likely the target user is to visit bars frequently, and the more likely the target user is to drink. Whether a place is a bar can be identified on the basis of map information obtained on the Internet or the like.

When the profile item “smoking” of the target user is “yes”, for example, the credibility evaluation unit 36 increases the credibility of the profile item if places where the target user has posted information on the SNS are smoking areas. This is because it is estimated that the more the target user posts information associated with a smoking area on the SNS, the more likely the target user is to visit smoking areas frequently, and the more likely the target user is to smoke. Whether a place is a smoking area, too, can be identified on the basis of map information obtained on the Internet or the like.

When a profile item “spouse” or “marriage history” of the target user is “yes”, for example, the credibility evaluation unit 36 increases the credibility of the profile item if a house located in a place where the target user has posted information indicating that he/she is at home on the SNS is relatively large (e.g., a three-bedroom apartment or larger, an area of 200 m² or larger, etc.). When the profile item “spouse” or “marriage history” of the target user is “no”, on the other hand, the credibility evaluation unit 36 reduces the credibility of the profile item if a house located in a place where the target user has posted information indicating that he/she is at home on the SNS is relatively large. This is because it is estimated that a place where the target user has posted information indicating that he/she is at home is the target user's home, and whether the target user lives on his/her own (i.e., whether the target user is unmarried) and whether the target user lives with a family member (i.e., whether the target user is married) can be estimated on the basis of the size of a house located in the place. The size of the house located in the place can be estimated on the basis of map information obtained on the Internet or the like.

### Method 1-4-2 for Evaluating Credibility of Profile Item

The credibility evaluation unit 36 evaluates the credibility of a profile item of the target user on the basis of a frequency at which the target user has posted information relating to a certain place on the SNS.

When the profile item “drinking” of the target user is “frequently”, for example, the credibility evaluation unit 36 increases the credibility of the profile item if a frequency at which the target user has posted information on the SNS in bars is high. If a frequency at which the target user has posted information on the SNS in bars is low when the profile item “drinking” of the target user is “frequently”, on the other hand, the credibility evaluation unit 36 reduces the credibility of the profile item. This is because it is estimated that the more the target user posts information associated with a bar on the SNS, the more likely the target user is to drink frequently.

### Method 1-4-3 for Evaluating Credibility of Profile Item

The credibility evaluation unit 36 evaluates the credibility of a profile item of the target user on the basis of places relating to information posted by the target user on the SNS and times of the posting.

When a profile item “days off” of the target user is “Saturdays and Sundays”, for example, the credibility evaluation unit 36 increases the credibility of the profile item if places where the target user has posted information on the SNS on Saturdays and Sundays are the target user's home. This is because it is estimated that the target user is at home when he/she posts information associated with the target user's home on the SNS and that dates on which the target user posts the information relating to the target user's home are likely to be days off. Information indicating a location of the target user's home may be registered to the SNS in advance.

### Method 1-4-4 for Evaluating Credibility of Profile Item

The credibility evaluation unit 36 evaluates the credibility of a profile item of the target user on the basis of a result of an analysis of images posted by the target user on the SNS and places relating to the images.

When a profile item “pet” of the target user is “yes”, for example, the credibility evaluation unit 36 increases the credibility of the profile item if the target user has posted, at the target user's home, a photograph showing a pet. This is because it is estimated that when the target user has posted a photograph of a pet associated with the target user's home on the SNS, the pet on the photograph is at the target user's home and the target user is likely to have the pet.

### Method 1-5 for Evaluating Credibility of Profile Item

The credibility evaluation unit 36 evaluates the credibility of a profile item of the target user on the basis of information in which the target user has shown interest in the SNS.

### Method 1-5-1 for Evaluating Credibility of Profile Item

The credibility evaluation unit 36 evaluates the credibility of a profile item of the target user on the basis of items positively reacted to by the target user in the SNS.

When the profile item “hobbies” of the target user is “classical music”, for example, the credibility evaluation unit 36 increases the credibility of the profile item if the target user has positively reacted to information relating to classical music posted by other users and accounts relating to classical music in the SNS. This is because it is estimated that the more the target user positively reacts to information regarding classical music in the SNS, the more likely the target user is to be interested in classical music.

When a profile item “languages” of the target user is “English”, for example, the credibility evaluation unit 36 increases the credibility of the profile item if the target user has positively reacted to information that has been posted by other users and that is written in English or that includes a moving image in which English is spoken and accounts relating to English books. This is because it is estimated that the more the target user positively reacts to information regarding English or an English book in the SNS, the more likely the target user is to be interested in English, and the more likely the target user is to be good at English, that is, able to speak English.

### Method 1-5-2 for Evaluating Credibility of Profile Item

The credibility evaluation unit 36 evaluates the credibility of a profile item of the target user on the basis of a community in which the target user participates in the SNS.

When the profile item “hobbies” of the target user is “classical music”, for example, the credibility evaluation unit 36 increases the credibility of the profile item if the target user participates in a community relating to classical music in the SNS. This is because it is estimated that if the target user participates in a community relating to classical music in the SNS, the target user is likely to be interested in classical music.

### Method 2 for Evaluating Credibility of Profile Item

In a second method, the credibility evaluation unit 36 evaluates the credibility of a profile item of the target user on the basis of information regarding related users, who relate to the target user, in the SNS included in the information regarding the target user obtained from the SNS.

### Method 2-1-1 for Evaluating Credibility of Profile Item

The credibility evaluation unit 36 evaluates the credibility of a profile item of the target user on the basis of information posted by the related users on the SNS.

When a profile item “qualifications” of the target user is “patent attorney”, for example, the credibility evaluation unit 36 increases the credibility of the profile item if the related users have posted information relating to patent attorneys on the SNS. This is because it is estimated that the more the related users post information regarding patent attorneys on the SNS, the more likely the related users are to be patent attorneys, and the more likely the target user, to whom the related users relate, is also to be a patent attorney.

### Method 2-1-2 for Evaluating Credibility of Profile Item

The credibility evaluation unit 36 evaluates the credibility of a profile item of the target user on the basis of a type of relationship between an account of the target user and an account of another user for the SNS.

When a profile item “siblings” of the target user is “yes”, for example, the credibility evaluation unit 36 increases the credibility of the profile item if there is an account of another user that has a relationship of “brother” or “sister” with the account of the target user in the SNS. When the profile item “siblings” of the target user is “no”, on the other hand, the credibility evaluation unit 36 reduces the credibility of the profile item if there is an account of another user that has a relationship of “brother” or “sister” with the account of the target user in the SNS.

When the profile item “spouse” or “marriage history” of the target user is “yes”, for example, the credibility evaluation unit 36 increases the credibility of the profile item if there is an account of another user that has a relationship of “husband” or “wife” with the account of the target user in the SNS. When the profile item “spouse” or “marriage history” of the target user is “no”, on the other hand, the credibility evaluation unit 36 reduces the credibility of the profile item if there is an account of another user that has a relationship of “husband” or “wife” with the account of the target user in the SNS.

### Method 2-1-3 for Evaluating Credibility of Profile Item

The credibility evaluation unit 36 evaluates the credibility of a profile item of the target user on the basis of a community in which the related users participate in the SNS.

When a profile item “educational background” of the target user is “University of Tokyo”, for example, the credibility evaluation unit 36 increases the credibility of the profile item if many of the related users participate in communities relating to the University of Tokyo (e.g., communities of circles of the University of Tokyo, communities of societies for the study relating to the University of Tokyo, etc.) in the SNS. This is because it is estimated that when the related users participate in communities relating to the University of Tokyo in the SNS, the related users have graduated from or attend the University of Tokyo and the target user, to whom the related users relate, has also graduated from or attends the University of Tokyo.

As in the case of the profile item “educational background”, when a profile item “occupational category” of the target user is “doctor”, for example, the credibility evaluation unit 36 increases the credibility of the profile item if many of the related users participate in communities relating to doctors (e.g., communities of academic societies of doctors) in the SNS. As in the case of the profile item “educational background”, when the profile item “qualifications” of the target user is “patent attorney”, for example, the credibility evaluation unit 36 increases the credibility of the profile item if many of the related users participate in communities relating to patent attorneys in the SNS. As in the case of the profile item “educational background”, when the profile item “hobbies” of the target user is “classical music”, for example, the credibility evaluation unit 36 increases the credibility of the profile item if many of the related users participate in communities relating to classical music in the SNS.

### Method 2-2 for Evaluating Credibility of Profile Item

The credibility evaluation unit 36 evaluates the credibility of a profile item of the target user on the basis of basic data regarding the related users managed by the SNS.

For example, the credibility evaluation unit 36 evaluates the credibility of the profile item “educational background” on the basis of educational backgrounds of the related users in the SNS. When the profile item “educational background” of the target user is “University of Tokyo”, for example, the credibility evaluation unit 36 increases the credibility of the profile item if educational backgrounds of many of the related users include the University of Tokyo in the SNS. This is because it is estimated that the larger the number of related users who have graduated from or attend the University of Tokyo, the more likely the target user is also to have graduated from or attend the University of Tokyo.

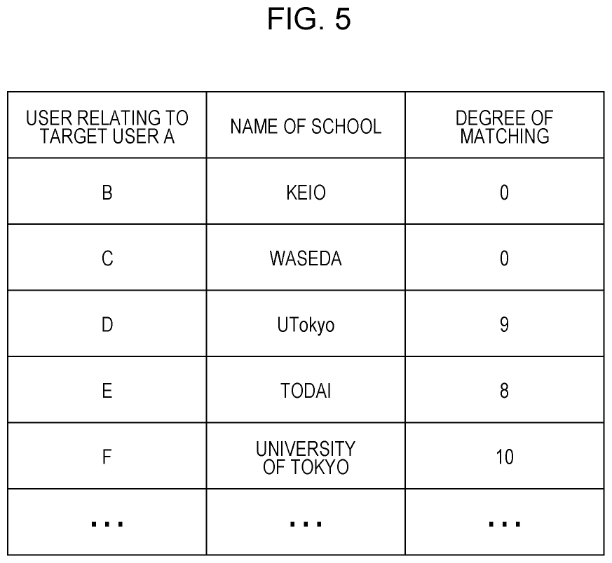

This method will be described in detail hereinafter. It is assumed that the target user has input “University of Tokyo” for the profile item “educational background” in the profile publication service. In this case, the credibility evaluation unit 36 extracts names of schools, which are data corresponding to the profile item, in the basic data of the accounts of all the related users relating to the account of the target user in the SNS. As illustrated in FIG. 5, for example, the credibility evaluation unit 36 extracts “Keio”, “Waseda”, “UTokyo”, “Todai”, and “University of Tokyo”, which are names of schools of related users B, C, D, and F, respectively.

The credibility evaluation unit 36 calculates a degree of matching between “University of Tokyo”, which has been input by the target user in the profile publication service, and the extracted name of the school input by each of the related users. A known method (e.g., a method based on the Levenshtein distance) may be used to calculate a degree of matching between words, and detailed description of such a method is omitted here. FIG. 5 illustrates degrees of matching between “University of Tokyo”, which has been input by the target user, and the names of the schools input by the related users. As for the related users B and C, for example, the degree of matching between “University of Tokyo” and “Keio” or “Waseda” is 0 (the larger the value, the higher the degree of matching). As for the related user D, the degree of matching between “University of Tokyo” and “UTokyo” is 9, and as for the related user E, the degree of matching between “University of Tokyo” and “Todai” is 8. As for the related user F, the degree of matching between “University of Tokyo” and “University of Tokyo” is 10.

The credibility evaluation unit 36 evaluates the credibility of the profile item of the target user on the basis of the degrees of matching calculated for the related users. One of various methods may be used to evaluate the credibility of the profile item based on degrees of matching. If the number of related users whose degrees of matching are higher than or equal to a certain degree threshold is larger than or equal to a certain number threshold, for example, the credibility evaluation unit 36 may evaluate the profile item as real. If not, the credibility evaluation unit 36 may evaluate the profile item as fake. Alternatively, if the percentage of the number of related users whose degrees of matching are higher than or equal to the certain degree threshold is higher than or equal to a certain percentage threshold, the credibility evaluation unit 36 may evaluate the profile item as real. If not, the credibility evaluation unit 36 may evaluate the profile item as fake. The above degree threshold, number threshold, and percentage threshold may be appropriately set by a manager of the profile evaluation apparatus 18 or the like.

When sequentially analyzing the degrees of matching for the related users in these cases, the credibility evaluation unit 36 may stop the analysis halfway and evaluate the profile item as real if it is found that the number of related users whose degrees of matching are higher than or equal to the degree threshold is larger than or equal to the number threshold, or if it is found that the percentage of the number of related users whose degrees of matching are higher than or equal to the degree threshold is higher than or equal to the percentage threshold, before the analysis of the degrees of matching is completed for all the related users. If it is found that the number of related users whose degrees of matching are higher than or equal to the degree threshold is smaller than the number threshold, or if it is found that the percentage of the number of related users whose degrees of matching are higher than or equal to the degree threshold is smaller than the percentage threshold, before the analysis of the degrees of matching is completed for all the related users, for example, the credibility evaluation unit 36 may stop the analysis halfway and evaluate the profile item as fake.

Alternatively, the credibility evaluation unit 36 may calculate an evaluation value of the credibility of the profile item on the basis of a representative value (e.g., an average) of the degrees of matching calculated for the related users.

An example of the method for evaluating the credibility of the profile item “educational background” input by the target user based on the basic data regarding the related users has been described.

In addition, the credibility evaluation unit 36 may evaluate the credibility of the profile item “occupational category” or “place of employment”, for example, on the basis of occupational categories or places of employment of the related users in the SNS. When the target user has input “cook” for the profile item “occupational category”, for example, the credibility evaluation unit 36 may evaluate the profile item as credible if the occupational categories of many of the users relating to the target user is “cook” in the SNS. The same specific method as for the profile item “educational background” may be used to calculate the credibility of the profile item “occupational category” or “place of employment”.

When the profile item “age” of the target user is “30”, for example, the credibility evaluation unit 36 may evaluate the profile item as credible if the age of many of the users relating to the target user is around 30 in the SNS. If the age of many of the users relating to the target user is not around 30 (e.g., 50 or older) in the SNS even though the profile item “age” of the target user is “30t”, the credibility evaluation unit 36 may evaluate the profile item as incredible. This is because related users are usually as old as a target user in an SNS. If many of the related users are around 30, therefore, it is estimated that the target user is likely to be also around 30.

### Method 2-3 for Evaluating Credibility of Profile Item

When evaluating the credibility of a profile item of the target user on the basis of information (not limited to the basic data regarding the related users) regarding the related users in the SNS, the credibility evaluation unit 36 may change a degree of importance of information regarding each of the related users on the basis of a degree of relationship between the target user and the related user in the SNS. In other words, the credibility evaluation unit 36 may evaluate the credibility of the profile item of the target user while putting more weight on information regarding a first related user relating to the target user in the SNS than information regarding a second related user whose degree of relationship with the target user is lower than that of the first related user with the target user in the SNS.

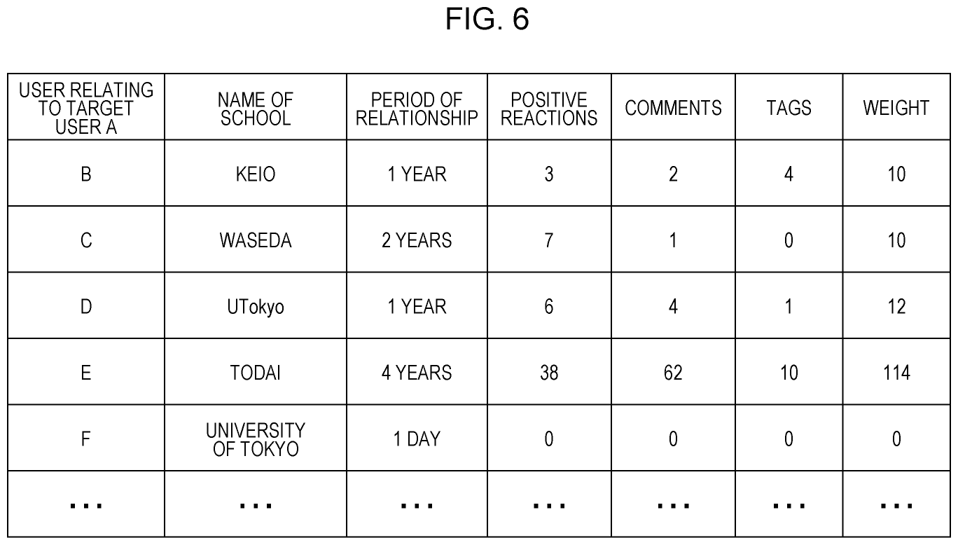

This method will be described in detail with reference again to the example where the credibility of the profile item “educational background” is evaluated, that is, more specifically, the example where the target user has input “University of Tokyo” for the profile item “educational background”. FIG. 6 illustrates information regarding the related users in the SNS.

First, the credibility evaluation unit 36 calculates a degree of relationship between the target user and each of the related users. One of various methods may be used to calculate the degree of relationship, and an example of such a method will be described hereinafter. In the present exemplary embodiment, the credibility evaluation unit 36 calculates the degree of relationship of each of the related users with the target user on the basis of a period of relationship, the number of positive reactions, the number of comments, and the number of tags of the related user.

The period of relationship is a period for which the user has related to the target user in the SNS. The longer the period of relationship, the higher the degree of relationship with the target user.

The number of positive reactions is the number of times the target user has positively reacted to information posted by the related user (e.g., the number of times the target user has pressed the “like” button), the number of times the related user has positively reacted to information posted by the target user, or the sum of these. The larger the number of positive reactions, the higher the degree of relationship with the target user.

The number of comments is the number of comments given by the target user to information posted by the related user, the number of comments given by the related user to information posted by the target user, or the sum of these. The larger the number of comments, the higher the degree of relationship with the target user.

The number of tags is the number of times the target user has been tagged in information posted by the related user, the number of times the related user has been tagged in information posted by the target user, or the sum of these. The larger the number of tags, the higher the degree of relationship with the target user.

The calculated degree of relationship of a related user with the target user is used as a weight indicating a degree of importance of information posted by the related user when the credibility of a profile item of the target user is evaluated. This is because it is considered that information posted by a related user whose degree of relationship with the target user is high reflects characteristics of the target user more strongly. This is also because it is considered that information posted by a related user whose degree of relationship with the target user is high is reliable as information that supports the credibility of a profile item of the target user.

A weight for a related user whose relationship with the target user is a relative (e.g., “husband”, “wife”, “parent”, “child”, etc.) in the SNS may be greater than those for other related users (e.g., friends). This is because it is considered that information posted by a related user who is a relative of the target user is more reliable than information posted by other related users as information that supports the credibility of a profile item of the target user.

The credibility evaluation unit 36 evaluates the credibility of a profile item of the target user in consideration of the weights calculated for the related users. When the profile item “educational background” of the target user is “University of Tokyo”, for example, the credibility evaluation unit 36 increases the credibility of the profile item unlike when weights are not taken into consideration, if a weight for a related user whose name of a school in basic data for the SNS is “University of Tokyo” is greater than a weight for a related user whose name of a school in basic data for the SNS is “Keio”. If the weight for the related user whose name of a school in the basic data for the SNS is “University of Tokyo” is smaller than the weight for the related user whose name of a school in the basic data for the SNS is “Keio”, on the other hand, the credibility evaluation unit 36 reduces the credibility of the profile item unlike when weights are not taken into consideration.

Examples of the method for evaluating a profile item of the target user used by the credibility evaluation unit 36 have been described. Profile items to be evaluated, however, are not limited to those described above, and specific methods for evaluating a profile item are not limited to those described above.

FIG. 4 will be referred to again. The notification control unit 38 outputs, for the target user, various notifications about a process for evaluating the credibility of a profile item of the target user performed by the credibility evaluation unit 36. In the present exemplary embodiment, the notification control unit 38 makes the notifications by displaying messages on the display of the user terminal 12. A notification method to be used, however, is not limited to this.

If an account ID indicating an account for an SNS is not associated with the user ID indicating the target user in the user information for the profile publication service, that is, the profile publication service and the SNS are not linked to each other for the target user, for example, the notification control unit 38 notifies the target user that the profile publication service and the SNS are not linked to each other. For example, the notification control unit 38 displays a message such as “Profile publication service and SNS are not currently linked to each other. You can continue to use profile publication service without link, but if you link, credibility of input profile items can be evaluated” on the display of the user terminal 12. The target user may perform a process for linking the profile publication service and the account thereof for the SNS to each other, that is, a process for registering a linked SNS, in response to the notification.

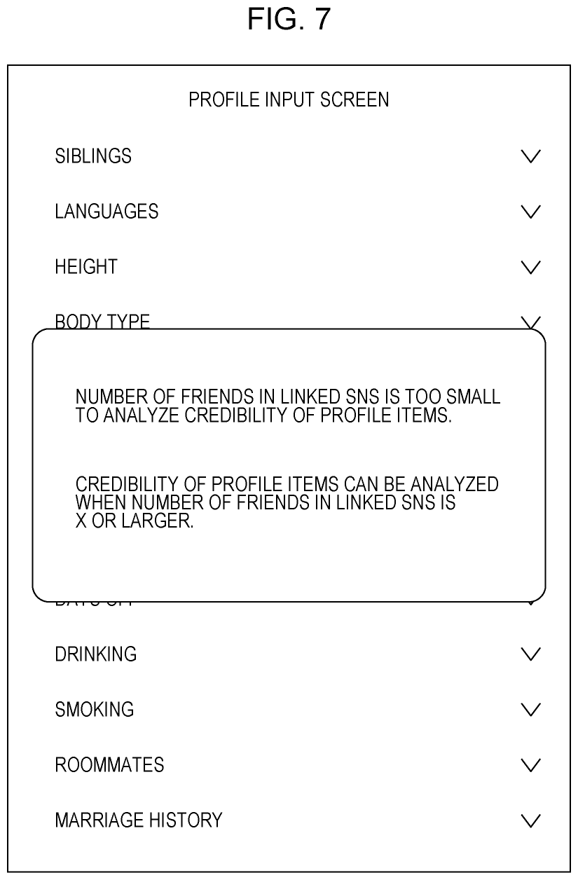

If the number of related users in the SNS is smaller than a certain first number threshold, the notification control unit 38 notifies the target user that it is difficult to evaluate the credibility of profile items of the target user. The first number threshold may be appropriately set by the manager of the profile evaluation apparatus 18 or the like. This is because when the credibility evaluation unit 36 evaluates the credibility of a profile item of the target user on the basis of information regarding the related users (the second method), it is difficult to appropriately evaluate the credibility of the profile item of the target user if the number of related users is too small. A concept that it is difficult to evaluate the credibility of a profile item of the target user includes incapability of evaluating the credibility of a profile item and extremely low reliability of a result of the evaluation of the credibility of a profile item. For example, the notification control unit 38 displays, as illustrated in FIG. 7, a message such as “Number of friends in linked SNS is too small to analyze credibility of profile items” on the display of the user terminal 12.

The target user may also be notified of a minimum required number of related users for evaluating the credibility of profile items in the SNS, that is, the first number threshold. For example, the notification control unit 38 displays, as illustrated in FIG. 7, a message such as “Credibility of profile items can be analyzed when number of friends in linked SNS is X (first number threshold) or larger” on the display of the user terminal 12.

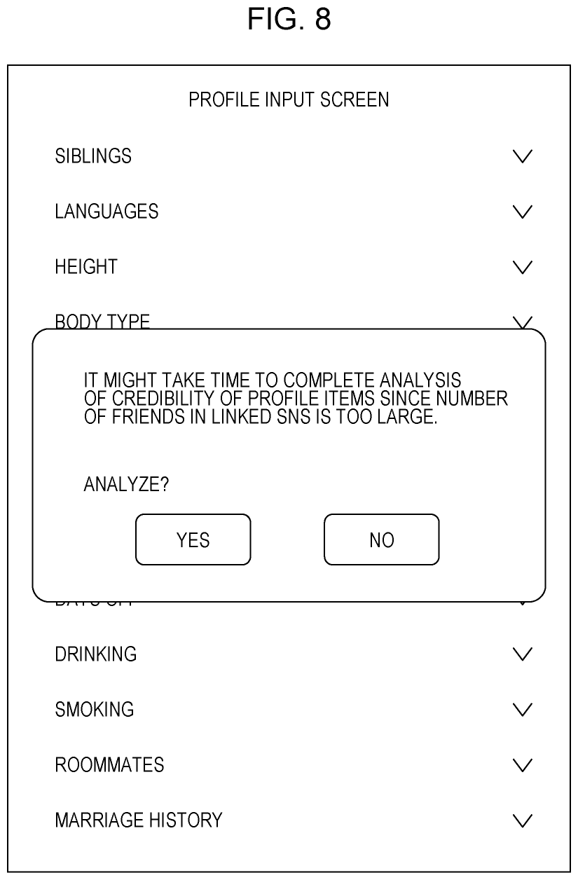

If the number of related users in the SNS is larger than or equal to a certain second number threshold, which is higher than the first number threshold, the notification control unit 38 notifies the target user that the amount of processing for evaluating the credibility of profile items of the target user will be large. The second number threshold may be appropriately set by the manager of the profile evaluation apparatus 18 or the like. This is because when evaluating the credibility of a profile item of the target user on the basis of the information regarding the related users, the credibility evaluation unit 36 needs to analyze an enormous amount of information if the number of related users is too large. A concept that the amount of processing for evaluating the credibility of a profile item of the target user will be large includes a long time taken to complete the evaluation of the credibility of a profile item and a large burden on the profile evaluation apparatus 18 for the evaluation of the credibility of a profile item. For example, the notification control unit 38 displays, as illustrated in FIG. 8, a message such as “It might take time to complete analysis of credibility of profile items since number of friends in linked SNS is too large” on the display of the user terminal 12.

Even when the amount of processing for evaluating the credibility of a profile item is too large, the target user may be asked whether to evaluate the credibility of the profile item. For example, the notification control unit 38 may display, as illustrated in FIG. 8, “yes” and “no” buttons along with a message such as “Analyze?” on the display of the user terminal 12. If the user presses the “yes” button, the credibility evaluation unit 36 evaluates the credibility of the profile item, and if the user presses the “no” button, the credibility evaluation unit 36 does not evaluate the credibility of the profile item.

FIG. 4 will be referred to again. The registration restriction unit 40 restricts registration, to the profile publication service, of a profile item of the target user input to the profile publication service on the basis of the credibility of the profile item evaluated by the credibility evaluation unit 36. As a result, registration of a profile item whose credibility is low to the profile publication service is suppressed.

If the credibility evaluation unit 36 determines that a profile item input by the target user to the profile publication service is fake, for example, the registration restriction unit 40 restricts registration of the profile item. In other words, the registration restriction unit 40 prevents the profile item from being registered to the profile publication service. If the credibility evaluation unit 36 determines that the profile item is real, on the other hand, the registration restriction unit 40 permits registration of the profile item to the profile publication service.

When the credibility evaluation unit 36 calculates the credibility of a profile item as a numerical value, the registration restriction unit 40 prevents the profile item from being registered to the profile publication service if the credibility of the profile item is lower than a certain restriction threshold. If the credibility of the profile item is higher than or equal to the restriction threshold, on the other hand, the registration restriction unit 40 permits registration of the profile item to the profile publication service.

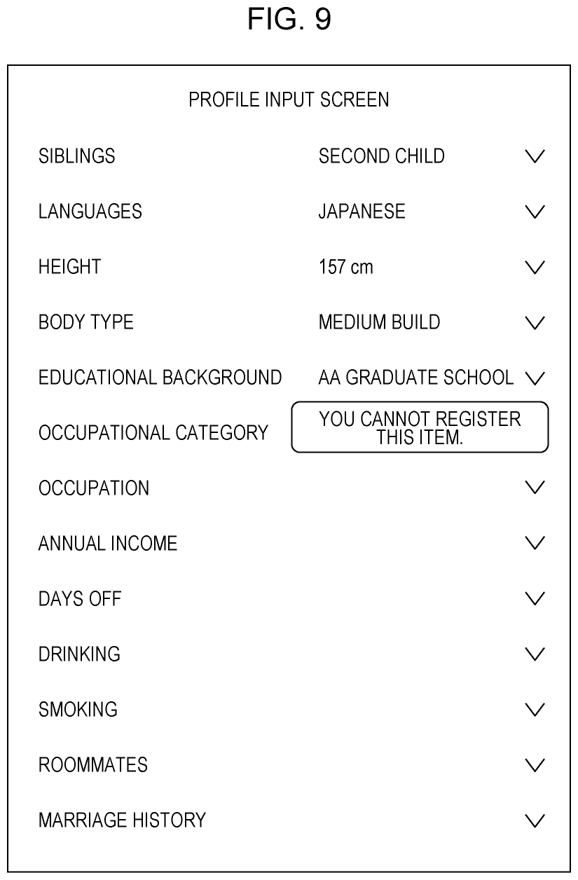

When the registration restriction unit 40 restricts registration of the profile item, the notification control unit 38 may notify the target user that the profile item cannot be registered to the profile publication service. For example, the notification control unit 38 may display, as illustrated in FIG. 9, a message such as “You cannot register this item” on the display of the user terminal 12.

FIG. 4 will be referred to again. When a viewer, who is a user other than the target user, views a profile item of the target user registered to the profile publication service, the display control unit 42 displays the profile item on the display of the user terminal 12 used by the viewer in a mode according to the credibility of the profile item evaluated by the credibility evaluation unit 36. As a result, the viewer recognizes the credibility of the profile item of the target user.

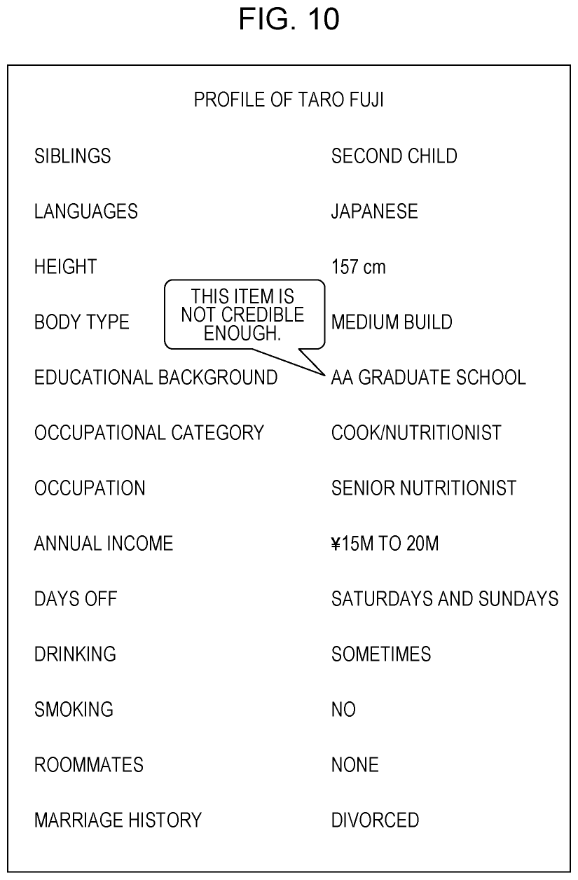

If the credibility evaluation unit 36 determines that the profile item “educational background” input by the target user is fake, for example, the display control unit 42 displays, as illustrated in FIG. 10, a message such as “This item is not credible enough” on the display of the user terminal 12 used by the viewer for the profile item “educational background”. The display control unit 42 may display a profile item of a target user in another mode insofar as the viewer can recognize as a degree of credibility of the profile item. For example, the display control unit 42 may display a profile item whose credibility is high in blue, a profile item whose credibility is low in red, and a profile item whose credibility is moderate in green.

An outline of the profile evaluation system 10 according to the present exemplary embodiment is as described above. With the profile evaluation system 10, the credibility evaluation unit 36 evaluates the credibility of a profile item input by the target user to the profile publication service. If the credibility of the profile item is low (more specifically, if the credibility evaluation unit 36 determines that the profile item is fake or if the credibility calculated by the credibility evaluation unit 36 for the profile item is lower than the restriction threshold), the registration restriction unit 40 restricts registration of the profile item to the profile publication service. As a result, the viewer does not view a profile item whose credibility is too low, and no disadvantage is caused to the viewer.

In addition, with the profile evaluation system 10, when the viewer views a profile item of the target user, the display control unit 42 displays the profile item of the target user in a mode according to the credibility of the profile item. As a result, the viewer recognizes the credibility of the profile item of the target user. The viewer does not view a profile item whose credibility is to low, and no disadvantage is caused to the viewer.

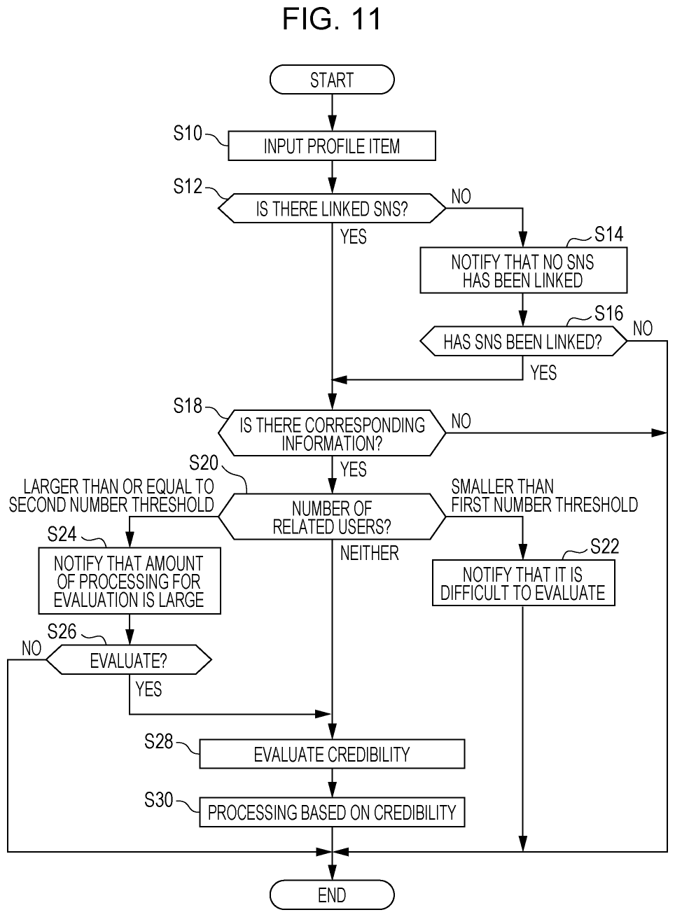

An example of a process performed by the profile evaluation apparatus 18 according to the present exemplary embodiment will be described hereinafter with reference to a flowchart of FIG. 11. The following example is a process performed when the credibility evaluation unit 36 evaluates the credibility of a profile item of the target user on the basis of information regarding the related users in the SNS (the above-described second method).

In step S10, the target user inputs a profile item to the profile publication service. The profile evaluation apparatus 18 receives an instruction to perform the process for evaluating the credibility of the profile item input to the profile publication service and obtains, from the profile publication service, the user ID indicating the target user and the profile item input by the target user.

In step S12, the processor 34 of the profile evaluation apparatus 18 refers to the user information managed in the profile publication service and determines whether an account ID for an SNS is associated with the user ID obtained in step S10. That is, the notification control unit 38 determines whether there is an SNS linked to the profile publication service for the target user. If so, the process proceeds to step S18, and if not, the process proceeds to step S14.

In step S14, the notification control unit 38 notifies the target user that the profile publication service and an SNS have not been linked to each other for the target user. For example, the notification control unit 38 displays a message on the user terminal 12 used by the target user.

In step S16, the processor 34 determines whether the target user notified in step S14 has performed a process for linking the profile publication service and an SNS to each other. That is, the processor 34 again refers to the user information managed in the profile publication service and determines whether an account ID for an SNS is associated with the user ID obtained in step S10. If so, the process proceeds to step S18, and if not, the process ends.

In step S18, the processor 34 determines whether there is information corresponding to the profile item input in step S10 in the information regarding the related users in the linked SNS identified in step S12 or S16. The information corresponding to the profile item is, when the profile item input in step S10 is the profile item “educational background”, for example, “name of school” or the like included in the basic data regarding the related users. If there is such information, the process proceeds to step S20, and if not, the process ends.

In step S20, the processor 34 determines whether the number of related users in the SNS is smaller than the first number threshold, larger than or equal to the second number threshold, or neither, that is, larger than or equal to the first number threshold and smaller than the second number threshold.

If the number of related users is smaller than the first number threshold, the process proceeds to step S22. In step S22, the notification control unit 38 notifies the target user that it is difficult to evaluate the credibility of the profile item input in step S10. The process then ends.

If the number of related users is larger than or equal to the second number threshold, the process proceeds to step S24. In step S24, the notification control unit 38 notifies the target user that the amount of processing for evaluating the credibility of the profile item input in step S10 will be large.

In step S26, the processor 34 determines whether an instruction to evaluate the credibility of the profile item has been received from the target user in response to the notification in step S24. If so, the process proceeds to step S28, and if not, the process ends.

In step S28, the credibility evaluation unit 36 evaluates the credibility of the profile item input in step S10. A specific method for evaluating the credibility is as described above, and description thereof is omitted.

In step S30, the registration restriction unit 40 or the display control unit 42 performs a process according to a result of the evaluation of the credibility of the profile item performed in step S28. For example, the registration restriction unit 40 restricts registration of the profile item input in step S10 to the profile publication service. If a viewer views the profile item input in step S10 and registered to the profile publication service, the display control unit 42 displays the profile item on the display of a user terminal 12 used by the viewer in a mode according to the credibility of the profile item.

Although an exemplary embodiment of the present disclosure has been described, the present disclosure is not limited to the exemplary embodiment and may be modified in various ways without deviating from the scope of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A profile evaluation apparatus comprising:
a processor configured to
evaluate, in a case where users register profiles of the users, credibility of a profile item of a target user input to a profile publication service, which publishes the registered profiles, on a basis of information regarding the target user managed for a social networking service.

2. The profile evaluation apparatus according to claim 1,
wherein the processor is configured to
evaluate the credibility of the profile item of the target user on a basis of information posted by the target user on the social networking service.

3. The profile evaluation apparatus according to claim 2,
wherein the processor is configured to
evaluate the credibility of the profile item of the target user on a basis of a result of an analysis of an image posted by the target user on the social networking service.

4. The profile evaluation apparatus according to claim 2,
wherein the processor is configured to
evaluate the credibility of the profile item of the target user on a basis of a place relating to the information posted by the target user on the social networking service.

5. The profile evaluation apparatus according to claim 2,
wherein the processor is configured to
evaluate the credibility of the profile item of the target user on a basis of information in which the targets user has shown interest in the social networking service.

6. The profile evaluation apparatus according to claim 1,
wherein the processor is configured to
evaluate the credibility of the profile item of the target user on a basis of information regarding a related user, who relates to the target user, in the social networking service.

7. The profile evaluation apparatus according to claim 6,
wherein the processor is configured to
evaluate the credibility of the profile item of the target user on a basis of basic data regarding the related user managed by the social networking service.

8. The profile evaluation apparatus according to claim 6,
wherein the processor is configured to
evaluate the credibility of the profile item of the target user while putting more weight on information regarding a first related user, who relates to the target user, in the social networking service than on information regarding a second related user whose degree of relationship with the target user is lower than a degree of relationship of the first related user with the target user.

9. The profile evaluation apparatus according to claim 7,
wherein the processor is configured to
evaluate the credibility of the profile item of the target user while putting more weight on information regarding a first related user, who relates to the target user, in the social networking service than on information regarding a second related user whose degree of relationship with the target user is lower than a degree of relationship of the first related user with the target user.

10. The profile evaluation apparatus according to claim 6,
wherein the processor is configured to
notify, if a number of related users is smaller than a first number threshold, the target user that it is difficult to evaluate the credibility of the profile item of the target user.

11. The profile evaluation apparatus according to claim 6,
wherein the processor is configured to
notify, if a number of related users is larger than or equal to a second number threshold, the target user that an amount of processing for evaluating the credibility of the profile item of the target user will be large.

12. The profile evaluation apparatus according to claim 10,
wherein the processor is configured to
notify, if a number of related users is larger than or equal to a second number threshold, the target user that an amount of processing for evaluating the credibility of the profile item of the target user will be large.

13. The profile evaluation apparatus according to claim 1,
wherein the processor is configured to
restrict registration of the input profile item of the target input to the profile publication service on a basis of the credibility of the profile item.

14. The profile evaluation apparatus according to claim 13,
wherein the processor is configured to
obtain information regarding the target user managed by the social networking service immediately before evaluating the credibility of the profile item of the target user.

15. The profile evaluation apparatus according to claim 14,
the processor is configured to
obtain, at a moment when the profile item of the target user is input to the profile publication service, the information regarding the target user managed by the social networking service.

16. The profile evaluation apparatus according to claim 1,
wherein the processor is configured to
display, in a mode according to the credibility of the profile item of the target user registered to the profile publication service, the profile item on a display of a terminal used by a viewer who views the profile item.

17. The profile evaluation apparatus according to claim 1,
wherein the processor is configured to
notify, if the profile publication service and the social networking service are not linked to each other for the target user, the target user that the profile publication service and the social networking service are not linked to each other for the target user.

18. A non-transitory computer readable medium storing a program causing a computer to execute a process comprising:
evaluating, in a case where users register profiles of the users, credibility of a profile item of a target user input to a profile publication service, which publishes the registered profiles, on a basis of information regarding the target user managed for a social networking service.

19. A profile evaluation apparatus comprising:
processing means for evaluating, in a case where users register profiles of the users, credibility of a profile item of a target user input to a profile publication service, which publishes the registered profiles, on a basis of information regarding the target user managed for a social networking service.
